(19) United States
(12) Patent Application Publication
(10) Pub. No.: US 2021/0319398 A1
(43) Pub. Date: Oct. 14, 2021

(54) METHOD AND SYSTEM FOR AGGREGATE SHIPPING

(71) Applicant: Simpler Postage, Inc., San Francisco, CA (US)

(72) Inventors: Jarett Streebin, San Francisco, CA (US); Sawyer Bateman, San Francisco, CA (US)

(21) Appl. No.: 17/356,695

(22) Filed: Jun. 24, 2021

Related U.S. Application Data
(63) Continuation-in-part of application No. 15/902,881, filed on Feb. 22, 2018.
(60) Provisional application No. 62/462,061, filed on Feb. 22, 2017.

(51) Int. Cl. G06Q 10/08

(52) U.S. Cl. CPC G06Q 10/0834; G06Q 10/0833; G06Q 10/0838

(57) ABSTRACT

A method for aggregate shipping of a plurality of objects designated for a user including receiving shipping data associated with shipment of a first object of the plurality of objects; generating a personalized content model associated with the user based on the shipping data in combination with user data retrieved from a database; determining personalized content based on the personalized content model; providing the personalized content to the user; receiving supplementary shipping data associated with shipment of a second object selected by the user in response to provision of the personalized content; determining a batch parameter based on an analysis of the shipping data and the supplementary shipping data; and batching the first object and second object into an aggregate shipment based on the batch parameter.

### CROSS-REFERENCE TO RELATED APPLICATIONS

This application is a continuation in part of U.S. application Ser. No. 15/902,881, filed 22 Feb. 2018, which claims the benefit of U.S. Provisional Application Ser. No. 62/462,061, filed 22 Feb. 2017, each of which is incorporated herein in its entirety by this reference.

### TECHNICAL FIELD

This invention relates generally to the shipping services field, and more specifically to a new and useful method for aggregate shipping.

### BRIEF DESCRIPTION OF THE FIGURES

FIG. 1 is a chart representation of a variation of an embodiment of a method for aggregate shipping;

FIG. 2 is a schematic representation of variations of an embodiment of a method for aggregate shipping;

FIG. 3 is a schematic representation of variations of an embodiment of a method for aggregate shipping; and

FIG. 4 is a schematic representation of presenting personalized content and aggregate shipping options at a user device in a variation of an embodiment of a method for aggregate shipping.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Overview.

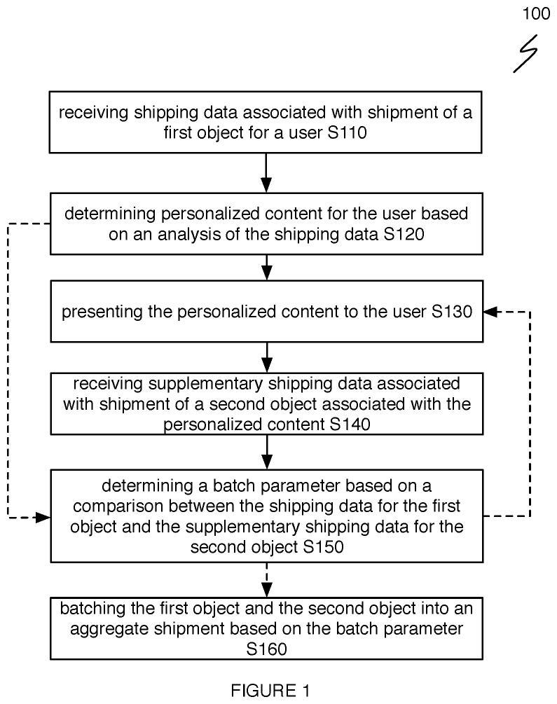

As shown in FIGS. 1-3, an embodiment of the method 100 can include: receiving shipping data associated with shipment of a first object for a user S110; determining personalized content for the user based on an analysis of the shipping data S120; presenting the personalized content to the user S130; receiving supplementary shipping data associated with shipment of a second object associated with the personalized content S140; and/or determining a batch parameter based on an analysis of the shipping data for the first object and the supplementary shipping data for the second object S150. The method 100 can additionally or alternatively include batching the first object and the second object into an aggregate shipment based on the batch parameter S160; and/or any other suitable operation.

The method 100 functions to improve the efficiency of shipping two or more objects to a single entity (e.g., an entity having a unique location, an individual user, a place of business, an address, etc.). The method can also function to improve experiences of end-use customers (e.g., users of the objects) by reducing the time and/or expense of shipping objects to such customers. The method can also function to automatically target the goods of multiple distinct purveyors (e.g., retailers of objects) to a single user that makes up a portion of a market that overlaps the multiple purveyors. The method 100 can also function to improve processing efficiency and database load associated with shipping a plurality of objects, such as by circumventing the need to determine and/or store shipping data (e.g., route data), tracking data (e.g., computationally predicted delivery estimates, etc.), and/or other shipping-related data for separate shipments. The method can also function to optimize routes of a plurality of objects destined for a single user across any suitable combination of multiple shipping carriers, multiple retailers, and multiple individual routes (e.g., routes that would otherwise be used for a single shipping carrier transporting a shipment from a single retailer). The method 100 can also function to promote items to a customer at a discount, in a manner that reduces overall shipping costs for the customer and/or retailer(s) involved, and/or in a manner that increases sales for retailers targeting similar markets.

The method 100 preferably involves the use of batch parameters. Batch parameters can be any parameter or set of parameters indicative of logistics for batching the two or more objects into an aggregate shipment. Examples of batch parameters are described below in Section 2, but can otherwise include any suitable parameters as noted above.

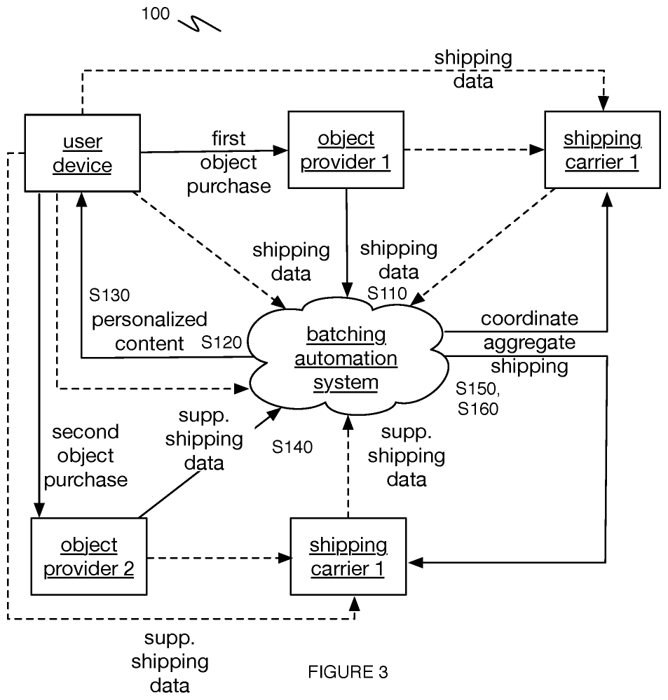

As shown in FIG. 3, the method 100 is preferably implemented by a batching automation system (BAS) (e.g., including a remote computing system managed by a shipping services platform), but any portion of the method 100 can be implemented by any suitable components, such as those described in U.S. application Ser. No. 14/481,078, filed 9 Sep. 2014, and U.S. application Ser. No. 15/429,039 filed 9 Feb. 2017, both of which are incorporated in their entirety by this reference.

Any portions of the method 100 and/or instances of a portion of the method 100 can be performed at predetermined time intervals (e.g., every minute, hour, day, etc.), in temporal relation to a trigger event, in serial (e.g., in response to, etc.), parallel (e.g., concurrently on different threads for parallel computing to improve system processing ability for aggregating shipping, etc.), and/or at any suitable time and any suitable frequency.

### 1.1 Benefits

Variations of the method(s) and system(s) can afford several benefits and/or advantages over traditional approaches to aggregating objects for shipment.

First, the technology can automatically retrieve and/or generate multiple types of shipping data (e.g., cross-carrier data such as historical delivery data for completed shipments across a plurality of carriers; parcel-specific data such as weight and selected service level; tracking data provided by a shipping carrier; contextual data such as weather data; etc.) in order to improve upon the accuracy and efficiency of personalized content and/or batch parameter determination.

Second, the technology can include an approach necessarily rooted in computer technology for overcoming a problem specifically arising in the realm of computer networks. In an example, the technology can automatically communicate with digital platforms of a plurality of shipping carriers (e.g., by generating API requests tailored to each different platform) to retrieve delivery data and/or parcel data to update batchability determination and/or batching models in real-time, thereby overcoming a technical problem of obtaining and leveraging shipment aggregation logistics data originating from a plurality of different digital platforms, shipping carriers, and locations.

Third, the technology can confer improvements to the functioning of computer-related technology. In an example, the technology can amount to an inventive distribution of functionality across a network of one or more: shipping carriers (e.g., with API and/or other digital platforms facilitating retrieval of delivery data and/or parcel data), delivery prediction systems (e.g., acting as a central hub of communication for retrieving delivery-related data from a plurality of sources to use in generating and/or executing delivery prediction models), batch determination systems (e.g., acting as a centralized hub of communication and/or data exchange for aggregating and analyzing object-related data from a plurality of sources to use in generating and/or executing batching models), delivery vehicles (e.g., which can be routed, re-routed, and/or otherwise controlled based on improved aggregation determination), users (e.g., shipping senders, shipping recipients, and/or other users who can leverage an API of a first part shipping services platform to utilize the batch determination system), and/or other suitable entities. In another example, the technology can apply computer-implemented rules (e.g., feature engineering rules for processing delivery data into an operable form for generating features indicative of batchability; user preference rules for determining format of aggregation logistics estimates; batchability estimate response rules for appropriately responding to a given batchability estimate; etc.) in conferring improvements to the computer-related technical field of determining aggregate shipments (e.g., batched shipments). In another example, the technology can improve the functioning of shipping logistics systems (e.g., freight logistics, supply chain management systems) by improving upon accuracy and efficiency of combining a plurality of objects into a single shipment, thereby improving the accuracy of shipping logistics systems in appropriately responding to the batchability estimates (e.g., a distribution center that is able to more accurately schedule shipment to users based on improved aggregation estimates for multiple products being received by the distribution center). In another example, the technology can improve automated computing systems that rely on updated object data and/or shipping data (e.g., factory inventory systems linked to production and/or shipment), where improved batch determination can lead to lower variance in operational conditions for decreasing computation time and resources required to allocate delivered physical resources and/or delivery (e.g., shipment) resources.

Fourth, the technology can transform a particular article to another state or thing. For example, the technology can transform one or more of: a user device (e.g., activating an application executing on a smart phone by pushing an event occurrence to a webhook endpoint integrated with the application, etc.), a delivery vehicle (e.g., automatically delivering a parcel with the delivery vehicle according to a service level selected based on determined batch parameters; routing and/or re-routing the delivery vehicle based on determined batch parameters), automated computing systems relying on determined batch parameters (e.g., distribution center systems, retail systems, etc.), and/or other suitable systems.

Fifth, variations of the method can enable multiple retailers that sell to a similar (e.g., overlapping) market (e.g., set of customers) to target a single customer without necessarily generating a primary selection (e.g., a sale or selection of a first object). For example, in response to a user (e.g., customer) selecting a first object from a first retailer, variations of the method can include receiving shipping data (e.g., product data) associated with the first object and providing personalized content to the user that includes related objects that the user may desire to add to her shipment. The related objects can include objects sold by a second distinct retailer that the user may not otherwise have encountered via the original purchasing portal (e.g., the website of the first retailer).

Sixth, variations of the method can improve shipping efficiency by aggregating shipping for two or more objects (e.g., from different retailers targeting the same customer, from a single retailer that sells a variety of goods, etc.) based on batch parameters. The two or more objects may otherwise be shipped separately, and the batch parameters define (e.g., determine, encode, describe, etc.) the logistical requirements of combining the two or more objects into a single shipment. For example, the two or more objects may be shipped using separate packaging (e.g., boxes, envelopes, etc.) but are combined into a single package via application of an example implementation of the method. In another example, the two or more objects may be otherwise shipped using separate shipping vehicles (e.g., different trucks, different types of shipping vehicles, the same truck according to different schedules, etc.) but are shipped via the same shipping vehicle according to a single schedule upon application of an example implementation of the method. In another example, the two or more objects may be otherwise shipped via different shipping carriers (e.g., UPS, USPS, DHL, FedEx, etc.) but are shipped via the same shipping carrier (e.g., from an intermediate location or aggregation location, from the origination location or first location, etc.) upon application of an example implementation of the method. In other specific examples, the two or more objects may be otherwise shipped with differing service levels, stamps, delivery trackers, and the like but for the application of the other specific example implementations of the method.

Seventh, variations of the method can improve user experiences (e.g., retail experiences) by lowering shipping costs to the user of shipping a plurality of objects from different retailers. For example, two retailers can have a mutual arrangement to share shipping costs in instances wherein the user batches multiple objects into a single shipment, lowering their respective operating costs and enabling the cost savings to be passed to the user. In another example, the user can save the cost of shipping multiple items that would have otherwise been shipped separately by combining the items into a single shipment.

Eighth, variations of the method can improve user experiences (e.g., retail experiences) by increasing shipping speed. For example, a first object may only be available for shipping via standard ground which may take an average of six business days, but also be available for batching into a shipment with additional objects (e.g., from the same retailer, a different retailer, etc.) and in such cases thereby available for shipping via a more rapid shipping method (e.g., service level).

However, the technology can provide any other suitable benefits in the context of using non-generalized systems for determining aggregated shipments.

### 2.1 Method—Receiving Shipping Data

Block S110 recites: receiving shipping data associated with shipment of a first object for a user. Block S110 functions to collect data informative (e.g., descriptive) of the first object and/or shipment of the first object. The shipping data is preferably used for determining personalized content, but can additionally or alternatively be used for evaluating and/or otherwise determining batch parameters, batching the two or more objects into an aggregate shipment, and/or any other suitable purpose.

Regarding Block S110, shipping data can include any one or more of: shipping carrier data (e.g., delivery vehicle data; service level data; rate quotes; handling times; status change data; etc.), object data (e.g., object type; dimensions; weight; density; construction materials; metadata; technical specifications; 3D models; etc.), route data (e.g., origin address, destination address, intermediary addresses, estimated transit times, historical transit times, etc.), contextual data (e.g., weather data; traffic data; data associated with the route, such as terrain of freeways included in the route; area demographics; etc.), user data (e.g., user purchase history tracked by an object provider, where the object provider can be one or more of the merchant selling the object, a manufacturer, a distribution center; etc.); user preferences (e.g., shipping cost thresholds, preferred delivery time of day, maximum shipping duration thresholds, minimum shipping duration thresholds, delivery instructions such as preferred location to leave a package, preference for discrete packaging such as unlabeled boxes, etc.), and/or any other suitable data.

In relation to Block S110, the shipping data can additionally or alternatively include any one or more of: current shipping data (e.g., associated with the shipment of the first object, shipping data that is already associated with an object being shipped at the time of reception, shipping data that is intrinsically and/or indelibly associated with the first object and therefore unlikely to change, etc.); historical shipping data (e.g., collected over time by the shipping carrier, stored at a central computing system by an entity that records shipping events by a single customer or a plurality of customers, third party records of shipping data, etc.); shipping features (e.g., parameters of the shipment, derived or computed or extracted parameters of the shipment, etc.), and/or any other suitable types of shipping data. Any one of the aforementioned types of shipping data can be extracted, derived, computed, and/or otherwise determined based on combining, comparing, normalizing, unit-standardizing, filtering, and/or otherwise suitably processing the shipping data.

In relation to Block S110, receiving shipping data can be performed through one or more of: API communications (e.g., API requests to access databases associated with the object provider and/or purveyor, a received API communication from an object provider using an API managed by the shipping services platform, a received API communication managed by a third party service in communication with both object providers and shipping services providers, etc.), webhooks, Internet scraping (e.g., scraping product descriptions at third part merchant websites for products matching the object, etc.), and/or any other suitable approach for obtaining shipping data.

In a variation, Block S110 can include generating shipping data requests. For example, Block S110 can include: in response to receiving a first set of shipping data for the first object from a shipping carrier, generating a plurality of shipping data requests (e.g., tailored to respective API platforms based on applying data request computer-implemented rules) to object providers associated with the first object; and collecting a second set of shipping data from responses to the shipping data requests. However, collecting shipment data can be implemented with any suitable mechanism.

In another variation, Block S110 can include establishing webhooks for automatically receiving shipping data. A webhook preferably enables an entity (e.g., a first party shipping platform; a user; etc.) to be automatically updated in response to an event occurrence (e.g., a shipping carrier updating their database with updated delivery data; a delivery prediction system generating an updated delivery estimate; etc.). A webhook preferably includes a webhook origin (e.g., from which an event occurrence notification is transmitted) and a webhook endpoint (e.g., to which the event occurrence is transmitted), but can include any suitable framework components. Additionally or alternatively, webhooks (e.g., endpoints, operations for processing data received through webhooks, etc.) can be established for automatically receiving and/or transmitting shipping data, and/or any other suitable data from any suitable entity (e.g., non-shipping carrier platforms). In an example, Block S110 can include establishing one or more webhook endpoint Uniform Resource Locators (URLs) for receiving communication from one or more carriers; and receiving data (e.g., delivery data, parcel data, etc.) through one or more Hypertext Transfer Protocol (HTTP) POST requests at the one or more webhook endpoint URLs in response to one or more event occurrences (e.g., a first carrier updating a delivery status change associated with the first tracking number). Additionally or alternatively, configuring a webhook (e.g., as part of Block S110) can be performed in any suitable manner.

For Block S110, shipment data is preferably received at the BAS from any one or more of: a shipping carrier (e.g., receiving the shipping data at a webhook endpoint established with a shipping carrier; through generating and transmitting an API request tailored to an API platform of the shipping carrier; etc.), an object provider (e.g., merchant, manufacturer, distributor, etc.), user (e.g., manually transmitted by the user through an API associated with the BAS; automatically transmitted by a smartphone application in response to using natural language processing to parse an order confirmation e-mail accessible through the smartphone; etc.), and/or any other suitable entity. However, shipment data can be received at any suitable component from any suitable entity. Block S110 is preferably performed in response to a user purchasing (e.g., selecting, choosing, etc.) the first object (e.g., at an e-commerce website, at a direct-to-consumer portal, at a pop-up retailer having a networked point-of-sale system, etc.), but can additionally or alternatively be performed at any suitable time (e.g., in response to receipt of the shipping data at the shipping carrier from the object provider). However, receiving shipping data can be otherwise performed in any suitable manner.

### 2.2 Method—Determining Personalized Content

Block S120 recites: determining personalized content for the user based on an analysis of the shipping data. Block S120 functions to determine content tailored to the user to enable subsequent objects (e.g., a second object) to be determined and aggregated with the first object into an aggregate shipment. Block S120 can also function to improve user experience (e.g., during content provision and/or reception by the user). and/or subsequent presentation of the content. Block S120 can include generating personalized content; for example, Block S120 can include synthetically generating a tailored video advertisement, based on characteristics of the first object described by the shipping data, that includes a set of objects related to the first object, and from which the user can select a second or further objects for purchase and aggregation. Block S120 can also include identifying and/or selecting personalized content; for example, Block S120 can include retrieving a wish list associated with the user and suggesting further objects for batching into an aggregate shipment based on batch parameters computed based on the shipping data and shipping data associated with the further object(s) (e.g., supplementary shipping data). However, Block S120 can include otherwise suitably determining personalized content for the user based on an analysis of the shipping data.

Regarding Block S120, personalized content can include any one or more of: related objects (e.g., a pair of jeans complementary to a purchased dress shirt, a smartphone accessory compatible with a purchased smartphone, a cleaning implement compatible with a purchased cleaning solution, a cleaning solution compatible with a purchased cleaning implement, an object necessary for practical utilization of the purchased object such as appropriate batteries, etc.), batchable objects (e.g., objects that can be batched with a purchased object in an aggregate shipment due to size constraints, weight constraints, relative location constraints, route constraints, timeline constraints, shipping mode constraints such as those for hazardous materials, etc.), advertisements (e.g., associated with products related to products included in a user purchase history, directed to products that demographically similar users have purchased, etc.), promotions (e.g., discounts for related objects for which the object provider has a high supply, discounts or deals for related objects sold by different object providers that have a mutual agreement, etc.), content resources (e.g., contextual content resources, such as hyperlinks to content associated with the shipping data, such as user manuals associated with the object; etc.), object metadata (e.g., store locations for stores with related object supply, object identifiers, images of the packaging, etc.), and/or any other suitable content. Personalized content can typify any suitable format, including any one or more of: verbal, numerical, textual, graphical, aural, haptic, and/or any suitable format of information communication. In variants, a subset of the personalized content can be contextual content—personalized content which is contextually tailored based on shipping information (e.g., based on the location, shipping timeline, route waypoints), object information (e.g., ‘batchability’, object metadata), contextual data from an external source (e.g., traffic data, weather at the time of order, etc.), and/or other suitable type of information relating to an existing order (e.g., thereby applying the ‘context’ of the previous order to inform personalized content generation).

In relation to Block S120, personalized content is preferably determined based on shipping data (e.g., parsed natural language content for a product description of the object being shipped, processed metadata associated with the object being shipped, contextually, based on contextual shipping content, etc.; contextual content which is contextually dependent on shipping data). Block S120 can additionally or alternatively be based on batch parameters (e.g., wherein the batch parameters can be determined based on shipping data or otherwise suitably determined). For example, the method 100 can include: identifying a set of related objects (e.g., based on product descriptions for related objects, based on compatibility between related objects sold by different retailers, etc.); determining batch parameters (e.g., calculating whether a cost savings can be obtained from aggregating shipping for one or more of the related objects and the purchased object, calculating whether a shipping time savings can be obtained from aggregating shipping, etc.) for each of the set of related objects; and determining personalized content based on the batch parameters (e.g., selecting a subset of related objects that lead to a faster delivery estimate through aggregate shipping with the purchased object; etc.).

In relation to Block S120, determining personalized content can additionally or alternatively be based on supplementary data (e.g., received independently from the shipping data, such as from a user device and/or third party, etc.), which can include any one or more of: user device data (e.g., device type, operating system, applications, etc.), additional user data (e.g., social media data such as social media posts, favorite content such as product descriptions, public profile data; etc.), any of the data types described in relation to shipping data, and/or any other suitable data. In examples, supplementary data can include supplementary shipping data, which can include any of the data types and/or be used in any of the manners described above in relation to shipping data. In other examples, supplementary data can include data unrelated to shipping and/or any other suitable data useful for determining personalized content (e.g., user data, contextual data, etc.).

In a variation, Block S120 can include: determining personalized content based on shipping data and supplementary data. In a specific example of the variation, Block S120 includes generating a virtual reality advertisement for a nutritional supplement based on data describing a first object wherein the first object is a diet book, and further based on supplementary data wherein the supplementary data includes a stored user profile including device information regarding a registered virtual reality headset. In the specific example, providing the personalized content includes rendering the virtual reality advertisement on the registered virtual reality headset (e.g., in real-time, in near-real time, asynchronously at a subsequent time when the user uses the virtual reality headset, etc.).

In another variation of Block S120, analyzing shipping data can include extracting shipping features (e.g., for use in generating and/or applying a personalized content model contextually based on an order) from shipping data, supplemental data, and/or other suitable data. Extracting shipping features (and/or other suitable portions of the method 100) can be based on one or more computer-implemented rules (e.g., feature engineering rules, feature selection rules, user preference rules, unit-standardization rules, etc.). In a variation, Block S120 can include applying a feature engineering rule to generate a shipping feature, such as through combining shipping data (e.g., current and historical shipping data). For example, Block S120 can include: generating an average of a set of delivery times and/or delivery estimates for shipments of objects specified in a user purchase history for the object provider; and selecting related objects for inclusion into personalized content, where the related objects are associated with estimated delivery times within a predetermined threshold of the average of the set of delivery times.

In another variation, Block S120 can include applying a feature selection rule (e.g., feature selection algorithms such as exhaustive, best first, simulated annealing, greedy forward, greedy backward, other suitable feature selection algorithms, etc.) to filter, rank, and/or otherwise select shipping features. For example, Block S120 can include: applying a first feature selection rule to select a first set of features (e.g., for generating a first personalized content model optimized for determining related objects with greatest similarity scores to the object being shipped); and, applying a second feature selection rule to select a second set of features (e.g., for generating a second personalized content model optimized for determining batchable objects associated with batch parameters minimizing the amount of packaging material required to ship the object and at least one of the batchable objects, etc.). However, applying computer-implemented rules to derive (e.g., extract) shipping features can be otherwise performed.

In another variation, Block S120 can include determining personalized content based on a personalized content model. The personalized content model is preferably generated based on one or more shipping features (e.g., derived and/or extracted as described above), but can additionally or alternatively be based on any other suitable shipping data and/or derived data. The personalized content model can additionally or alternatively be retrieved from a database, generated based on retrieved user data (e.g., user preference data), or otherwise suitably determined. The personalized content model can include any one or more of: probabilistic properties, heuristic properties, deterministic properties, and/or any other suitable properties. In an example, the personalized content model can assign weights to different types of shipping features (e.g., assign a greater weight to the similarity score between related objects and the object being shipped than to whether the potential objects are compatible or complementary objects), and output personalized content based on the weights and shipping feature values. The shipping features of the prior example and related examples can be input to the personalized content model, or the shipping features can be extracted from other input data (e.g., shipping data). In further examples and variations, the personalized content model can accept other data types such as user preference data, shipping data (e.g., shipping carrier data, object data, etc.), and any other suitable type of data.

In another example of Block S120, generating a personalized content model (and/or other portions of the method 100) can employ machine learning approaches including any one or more of: supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminate analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial lest squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or any suitable form of machine learning algorithm. In a specific example, Block S120 can include: training a personalized content model with a set of shipping feature vectors for a set of potential objects (e.g., different pieces of clothing associated with an object provider); extracting a shipping feature vector from shipping data for the object being shipped; selecting a subset of the set of potential objects (e.g., a predetermined number of a potential objects with similarity scores to the object being shipped exceeding a threshold similarity score) based on inputting the shipping feature vector into the personalized content model; and retrieving advertisements for the subset of potential objects, for inclusion into the personalized content (e.g., based on potential object identifiers stored in association with corresponding advertisements, based on potential object identifiers stored in association with compatible objects, etc.).

In another specific example, Block S120 can include generating and/or applying a neural network model (e.g., a convolutional neural network model), where visual features of the objects (e.g., pixel values for images of the objects) and/or other suitable shipping features can be used in the neural input layer of the neural network model. However, applying machine learning approaches can be performed in any suitable manner.

In further examples of Block S120, distinct (e.g., a plurality of different) personalized content models (e.g., generated with different algorithms, with different sets of features, etc.) can be utilized (e.g., determined, executed, etc.) based on one or more of: object providers (e.g., using a video-only personalized content model for a first object provider that preferentially delivers exclusively video content to their users, using a virtual reality personalized content model for an object purveyor that retails through virtual and/or augmented reality portals and/or endpoints, etc.), users (e.g., using an advertisement-based personalized content model for a first user with user preferences opting into receiving advertisements; using a content resource-based personalized content model for a second user that selects a preference for generated content based on stored content resource data, etc.), shipping carriers (e.g., using a personalized content model that is permitted by a particular shipping carrier), types of personalized content, and/or any other suitable criteria. For example, after shipping data associated with a first object is received, Block S120 can include using a personalized content model selecting from batchable objects shippable with a second carrier only if a shipping services platform database (e.g., from which data is retrieved) indicates requisite permissions between first and the second shipping carriers permitting aggregate shipping involving both carriers.

Regarding Block S120, determining personalized content preferably includes storing the personalized content in association with a user identifier identifying the user, to enable retrieval of the personalized content for presentation to the user, analysis of historical personalized content for subsequent instances of generating personalized content for the user, generation of a user profile for the user, and/or for any suitable purpose. However, determined personalized content can be stored in association with any suitable data (e.g., a business identifier, an address, a workspace, a geographic location, a geographic area such as a neighborhood, etc.). Storing the personalized content can, in variations, include storing parameters of a personalized content model (e.g., used to determine the personalized content) for later retrieval and determination of personalized content at a subsequent time point.

In a variation, the personalized content is associated with a supplemental object provider (e.g., a different merchant from the merchant who sold the object to the user), where the supplemental object provider can be a partner of the primary object provider (e.g., where the merchant identifiers for partner merchants are stored in association with each other), can be a partner of the shipping carrier selected by the user to ship the object (e.g., where a shipping carrier identifier is stored with a list of partner object providers), and/or can have any suitable relationship to the primary object provider, associated shipping carrier, and/or any suitable entity. In another variation, the personalized content is associated with supplemental users (e.g., social media friends of the user; family members of the user; household members; etc.), where the personalized content can be determined based on user data for supplemental users (e.g., stored profiles for the supplemental users). Additionally or alternatively, the personalized content can be associated with any suitable entity. However, determining personalized content can be performed in any suitable manner.

### 2.3 Method—Presenting Personalized Content

Block S130 recites: presenting (e.g., providing) the personalized content to the user. Block S130 functions to provide the personalized content determined in, e.g., Block S120, to the user. Presenting the personalized content can include transmitting the personalized content to one or more user devices associated with the user (e.g., pushing a notification including the personalized content to a user device registered with an application managed by the shipping services platform; presenting the personalized content at the same website used by the user to purchase the object; transmitting hyperlinks to the personalized content; transmitting based on user preference; etc.). Presenting the personalized content can additionally or alternatively include transmitting the personalized content to an object provider platform (e.g., through an API; based on object provider preferences; etc.) and/or object provider device (e.g., a point-of-sale device inside a merchant store, etc.) where the object provider can subsequently communicate the personalized content to the user. Presenting the personalized content can additionally or alternatively include activating a device associated with the user (e.g., generating and/or transmitting control instructions for the device to operate in accordance with the control instructions for presenting the personalized content). However, the personalized content can be presented and/or provided to the user through any other suitable means.

Presenting the personalized content to the user is preferably performed in response to determining the personalized content, but can additionally or alternatively be performed at any suitable time. In an example, Blocks S120 and S130 are performed within a predetermined time period after execution of Block S110 (e.g., wherein the personalized content is presented prior to the start of parcel handling for shipment of the object). However, presenting the personalized content can be performed in any suitable manner with any other suitable temporal behavior.

### 2.4 Method—Receiving Supplementary Shipping Data

Block S140 recites: receiving supplementary shipping data associated with shipment of a second object for the user. Block S140 functions to collect data informative of one or more objects for which batch parameters can be determined (e.g., in Block S150). The second object is preferably associated with the personalized content (e.g., wherein the second object is presented in the personalized content, such as in an advertisement and/or product description), but can alternatively be independent from the personalized content (e.g., not presented in the personalized content), and/or associated with any suitable data (e.g., shipping data for the first object, supplementary data, etc.). Block S140 can be repeated for any suitable number of objects (e.g., for each object or a subset of objects purchased in a digital shopping cart; for each object or a subset of objects purchased from the presented personalized content; for each object or a subset of objects presented in personalized content including a virtual reality showroom, etc.). Block S140 can be performed in any manner analogous to those described in relation to Block S110 (e.g., receiving the supplementary shipping data from an object provider in response to purchase of the second object by the user at the object provider platform). Additionally or alternatively, supplementary shipping data can be received in a different manner from shipping data. For example, the method 100 can include: passively receiving shipping data for a first object at a webhook endpoint established with the shipping carrier for the first object; and actively retrieving supplemental shipping data for a second object based on scraping product description information retrieved from performing an Internet search. However, receiving supplementary shipping data can be performed in any suitable manner.

### 2.5 Method—Determining a Batch Parameter

Block S150 recites: determining a batch parameter based on an analysis of the shipping data associated with the first object and the supplementary shipping data associated with the second object. Block S150 functions to evaluate the feasibility and/or logistics regarding aggregating shipping for a plurality of objects (e.g., including the first object and second object). The analysis of the shipping data and supplementary shipping data preferably includes a comparison between the shipping data and the supplementary shipping data, but can additionally or alternatively include any suitable analysis (e.g., applying a set of rules of any suitable type such as those described above, executing a model, etc.).

Regarding Block S150, batch parameters can include any one or more of: feasibility parameters (e.g., whether the objects can be aggregated into an aggregate shipment; whether a subset of the plurality of purchased objects can be aggregated; etc.); shipping carrier parameters (e.g., an updated shipping carrier for the aggregate shipment, such as UPS instead of USPS; an updated service level for shipping the aggregate shipment, which can be different or the same as the service level projected for the original shipment of the first object, such as Ground Shipping instead of Next Day Air; rate quote associated with the updated service level; updated delivery vehicles, such as airplane instead of drone; etc.); route parameters (e.g., the route between pickup locations for the first object and subsequent objects to be shipped in aggregate; associated addresses; route for the aggregate shipment to the destination address; updated delivery estimates; etc.); parcel parameters (e.g., aggregate weight of batched objects; aggregate dimensions of batched objects; etc.), user parameters (e.g., a set of user data for a plurality of users within proximal geographical distance, where multiple objects are aggregated into a single aggregate shipment to one of the plurality of users; user preferences for aggregate shipments, such as only allowing aggregate shipping in response to determining an updated delivery estimate as the same or faster than the original delivery estimate; etc.), and/or any other suitable parameters.

In relation to Block S150, determining a batch parameter is preferably based on an analysis (e.g., comparison, combination, normalization, filtering, unit standardization, using computer-implemented rules, etc.) of the shipping data for the first object and the supplementary shipping data for the second object. In an example, Block S150 can include determining an updated delivery estimate for an aggregate shipment based on analyzing a first individual delivery estimate for the first object and a second individual delivery estimate for the second object.

In a specific example, Block S150 can include: determining an aggregation time for shipping the first object to the location of the second object (e.g., or vice versa); generating a combined time based on combining the aggregation time with at least one of the first individual delivery estimate and the second individual delivery estimate (e.g., combining the aggregation time with the second individual delivery estimate in response to selecting the first object to be shipped to the second object, etc.); and generating an updated delivery estimate based on the combined time. However, determining delivery estimates can include any processes described in and/or analogous to U.S. application Ser. No. 15/429,074 filed 9 Feb. 2017, which is incorporated in its entirety by this reference.

In another example, Block S150 can include determining an aggregate route (e.g., for the aggregate shipment) based on a first individual route for the first object and a second individual route for the second object. The aggregate route is preferably a different route than either the first individual route or the second individual route, but can additionally or alternatively include: either the first individual route or the second individual route in its entirety as a portion of the aggregate route (e.g., wherein the first or second individual route represents a subset of the aggregate route), portions of the first individual route and/or the second individual route as portions of the aggregate route (e.g., wherein a subset of the first and/or second individual route are included as portions of the aggregate route).

In another example, Block S150 can include: determining an aggregation location (e.g., the location where the first and the second objects will be aggregated) based on the first and the second individual routes (e.g., determining a time and corresponding locations along the individual routes when the first and the second objects will be geographically closest); re-routing at least one of the first and the second individual routes to the aggregation location; and determining an aggregate route based on the aggregation location and the destination address (e.g., the fastest route from the aggregation location address to the destination address). The aggregation location can be a third-party shipping location (e.g., an independent shipping carrier from the shipping carrier or carriers shipping the first or second object), a designated shipment aggregation location (e.g., a warehouse, a distribution center, etc.), a retailer (e.g., the retailer of the first or second object), and/or any other suitable location otherwise suitably determined.

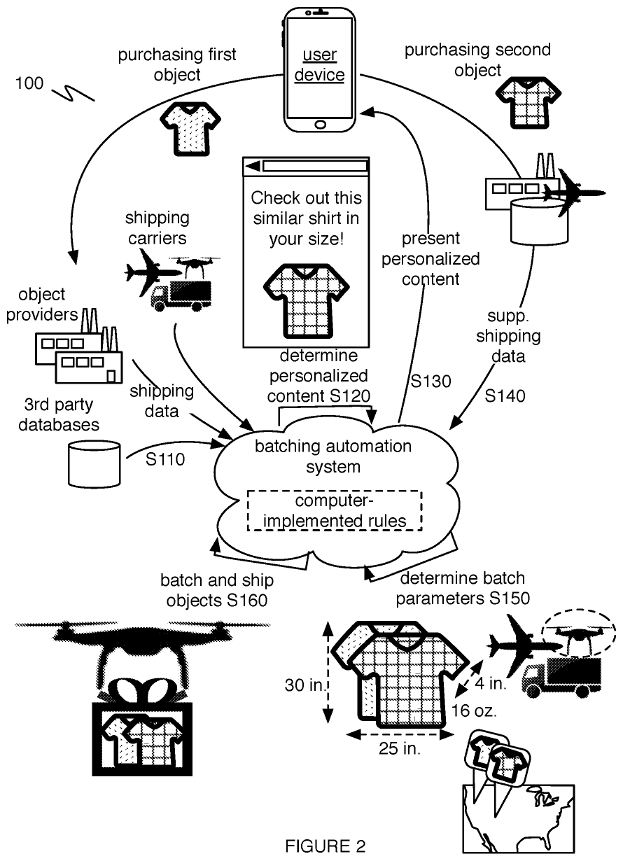

In another example, Block S150 can include determining an updated service level (e.g., for the aggregate shipment) based on first object data for the first object and second object data for the second object. In a specific example, as shown in FIG. 2, Block S150 can include: extracting a first and a second set of weight and dimensions parameters for the first and the second objects, respectively; generating aggregate weight and dimensions parameters for the aggregate shipment based on the first and the second sets of weight and dimensions parameters; identifying one or more service levels for shipping the aggregate shipment based on the aggregate weight and dimensions parameters, and on requirements (e.g., weight requirements; dimensions requirements; etc.) for the service levels. In another specific example, Block S150 can include determining a service level for shipping at least one of the first and the second objects to an aggregation location (e.g., shipping the first object to a distribution center housing the second object). In relation to the aforementioned, service level preferably describes at least one of the shipping speed (e.g., rush shipping, overnight shipping, standard ground, two-day shipping, Next Day Air, etc.), the shipping cost (e.g., insurance cost, postage cost, etc.), the shipping modality (e.g., ground delivery, air delivery, drone delivery, autonomous delivery robot delivery, etc.), and the like. However, determining service levels can include any processes described in and/or analogous to U.S. application Ser. No. 15/429,039 filed 9 Feb. 2017, which is incorporated in its entirety by this reference.

In another example, Block S150 can include applying a unit standardization rule to the shipping data and the supplementary shipping data (e.g., converting weight data for the first and the second objects to ounces, etc.), which can function to standardize the data across the first and the second objects to enable direct comparison of the data (e.g., wherein the data are expressed in the same units).

Regarding Block S150, determining a batch parameter is preferably based on a batching model. The basis and/or bases for determining the batching model can include any aspects included in and/or analogous to those described in relation to determining the personalized content model (e.g., using different batching models for different users, shipping carriers, other suitable criteria, etc.), and vice versa. In a variation, Block S150 can include applying a decision tree batching model with internal nodes and branches selected based on correlations between potential aggregate shipping-related outcomes and batch parameter values. For example, a decision tree batching model can start with determining a feasibility parameter (e.g., the objects can or cannot be shipped in an aggregate shipment) based on service level requirements and object data for the objects; and in response to determining an affirmative feasibility parameter, determining one or more subsequent batch parameters (e.g., updated delivery estimates based on contextual data, route data, and corresponding probabilities, such as chance of rainy weather vs. sunny weather on the aggregate route; etc.).

In another variation, Block S150 can include applying a batching model to output a similarity score between the shipping data and the supplementary shipping data. For example, Block S150 can include applying different weights to different types of shipping data (e.g., more heavily weighing a similarity between route data for the objects than a similarity in object type, etc.) for determining a similarity score; and determining one or more batch parameters (e.g., feasibility parameter) based on the similarity score (e.g., the similarity score exceeding a similarity score threshold).

In another variation, Block S150 can include applying a machine learning batching model, which can output any suitable batch parameter values. For example, Block S150 can include training a machine learning model based on known batch parameter values (e.g., delivery times for historical aggregate shipments; aggregate routes; updated service levels; feasibility parameters; etc.) and corresponding aggregate shipping features derived from sets of historical shipping data for sets of objects historically shipped in aggregate shipments (e.g., pairs of objects shipped in aggregate shipments for each pair); and estimating batch parameter values for a current aggregate shipment of the first and the second objects based on the shipping data and the supplementary shipping data.

In another variation of Block S150, applying a batching model can include chaining one or more models. In an example, the method 100 can include: outputting, with a personalized content model, shipping data for the objects presented in the personalized content; and using the shipping data to determine one or more batch parameters (e.g., which can be presented along with the shipping data). In another example, the method 100 can include: determining an updated delivery estimate with a delivery estimate model for an aggregate shipment; determining an updated service level with a service level determination model for the aggregate shipment; and inputting the updated delivery estimate and the updated service level into the batching model to determine a feasibility parameter based on the user preferences (e.g., cost below a threshold, delivery estimate of a certain speed, etc.).

Block S150 is preferably performed in response to receiving supplementary shipping data for the second object (e.g., in response to a user entering address details for shipping the second object in the user's digital shipping cart, etc.), but can be performed at any suitable time. However, determining batch parameters can be performed in any suitable manner.

### 2.6 Method—Batching Objects

The method 100 can additionally or alternatively include Block S160, which recites: batching the first object and the second object into an aggregate shipment based on the batch parameter (e.g., according to the updated service level and aggregate route). Block S160 functions to ship and/or otherwise facilitate the shipping of aggregate shipments. Block S160 is preferably based on one or more batch parameters (e.g., batching the first and the second objects at the aggregation location determined in Block S150), but can additionally or alternatively be based on any other suitable data (e.g., supplemental data, personalized content model outputs, user preferences, object provider preferences, shipping carrier preferences, etc.). Block S160 can include performing aggregate shipping and/or batching of a plurality of objects using one or more delivery vehicles including: automobiles, railway vehicles, aircraft, watercraft, combination of delivery vehicle types, autonomous vehicle, manually operated vehicles, and/or any other suitable vehicle types.

In a variation, Block S160 can include performing aggregate shipping with a plurality of shipping carriers. For example, Block S160 can include: in response to receipt of a first object at a second object location through a first shipping carrier (e.g., a third-party shipping carrier), batching the first and the second objects into an aggregate shipment at the second object location; and shipping the aggregate shipment to the destination address using a second shipping carrier (e.g., a first party shipping carrier).

In another variation, Block S160 can include performing aggregate shipping with a plurality of delivery vehicle types. For example, Block S160 can include: determining a distance between a first object location and a second object location; in response to the distance below a threshold distance, operating a delivery drone according to generated control instructions specifying delivery of at least one of the first and the second objects to an aggregation location; and in response to aggregating the first and the second objects at the aggregation location, shipping the aggregate shipment to the destination address with an automobile delivery vehicle. In another example, Block S160 can include: determining a terrain type between a first object location and a second object location; in response to determining that the terrain type is preferable for aerial drone delivery, operating an aerial delivery drone (e.g., such as a last-mile delivery drone) according to generated control instructions specifying the delivery of at least one of the first and second objects to an aggregation location; and in response to aggregating (e.g., batching) the first and second objects at the aggregation location, shipping the aggregate shipment to the destination address (e.g., determined based on user data, received from the user, etc.) using a ride-hailing-based delivery service.

In one example, batching objects can be performed in advance of last-mile delivery, such as at a last-mile distribution hub. However, batching objects can likewise occur at a first-mile hub, intermediary distribution hub, and/or any other suitable location.

In variants batching objects for last mile delivery, users can optionally receive objects in a soft-sided package such as a paper bag, plastic bag, (deformable) packing envelope, and/or other suitable soft-sided package. Soft-sided packages may be preferred for some users to reduce the burden of ‘unboxing’ a large, rigid, and/or heavy package, and can additionally minimize packaging waste. However, objects can be batched into any suitable packages.

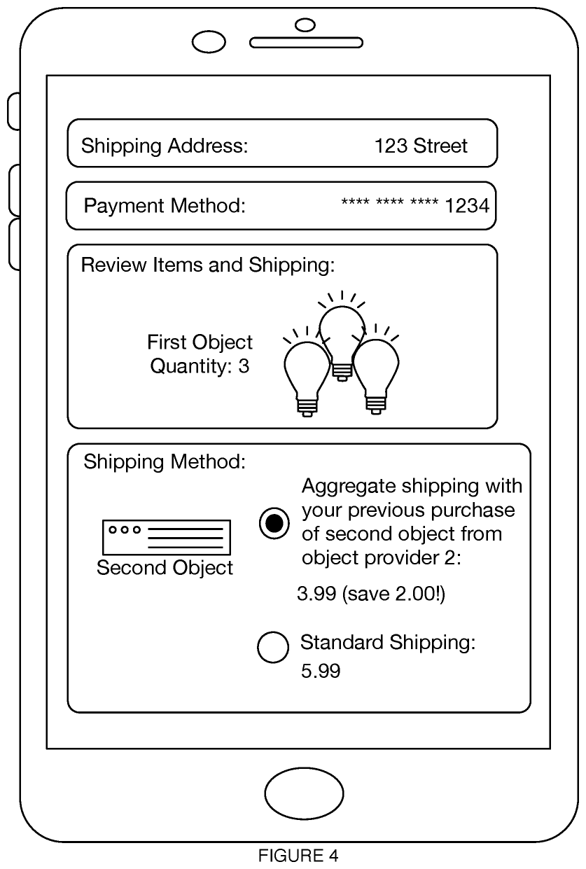

In another variation, Block S160 can include rerouting delivery vehicles to aggregate routes, object locations, and/or any suitable locations for facilitating aggregate shipping. Block S160 is preferably performed in response to manual user selection of a presented aggregate shipping option (e.g., presented in the purchasing process at an e-commerce website, as shown in FIG. 4), but can be automatically performed (e.g., in response to purchase of a batchable object based on user preferences, etc.), and/or at any suitable time. For example, a user can designate a list of objects that can be automatically purchased when the batched (e.g., aggregate) shipment cost falls below a specified cost threshold (e.g., inclusive or exclusive of the object price), and the method can include automatically adding one or more objects to the shipment (e.g., batching the objects) based on batch parameters, wherein the batch parameters are determined at least in part from the designated list of the user. However, Block S160 can be performed in any suitable manner.

### 3. Examples

In a first variant, a method for object aggregation for a user can include: determining an aggregate package parameter, including: based on a first of object selection by the user, receiving order data associated with a first object including a destination location for the user and a first location associated with the first object; generating a content model for the user based cooperatively on the order data and with historical data retrieved from a user database; using the content model, determining contextual content for the user; providing the contextual content to the user; receiving secondary order data associated a second object selection by the user in response to provision of the contextual content, wherein the secondary order data includes a second object location associated with the second object; and determining the aggregate package parameter based on an analysis of the order data and the secondary data; determining a package label based on the aggregate package parameter; and providing the package label for the first and second objects. In variants, providing the package label for the first and second objects includes: receiving the first object at an aggregation location, wherein the aggregation location is distinct from the destination location; receiving the second object at the aggregation location; at the aggregation location, packaging the first and second objects within an aggregate package; facilitating attachment of the package label to the aggregate package; and based on the package label, sending the aggregate package to the destination location.

In an example, the method can generate a different shipping label for each leg: a first label for shipping the first object from the first source location to the aggregate location, a second label for shipping the second object from the second source location to the aggregate location, and a third label for shipping the aggregate package to the destination location. The first and second labels can optionally be associated with each other, be associated with the third label, be associated with packaging instructions (e.g., to find the other object and/or package; type of packaging that should be used for the aggregate package; packaging method for the aggregate package; shipping timeline; etc.), and/or be associated with any other suitable data.

In examples of the first variant, the method can additionally include: receiving the first object via a first carrier; and receiving the second object via a second carrier, wherein the second carrier is distinct from the first shipping carrier. Additionally or alternatively, the first object can be assigned a first tracking number and the second object can be assigned a second tracking number, wherein status updates associated with the aggregate package are propagated to the first and second tracking numbers.

In examples, the system can provide the user with the tracking number for the first, second, and/or third label. The system preferably provides a single tracking number, but can alternatively provide multiple. The system can aggregate tracking information associated with the first, second, and third labels (e.g., from the respective carriers), and provide the aggregated tracking information to the user (e.g., in response to queries with the tracking number). The tracking information can be provided at an interface provided by the system, be provided at a third party carrier's interface (e.g., wherein the system provides the aggregate tracking information to the carrier, optionally signed with a system authentication key or with another authentication mechanism), and/or be otherwise provided.

In examples of the first variant, the method can additionally include: determining a distance between the first object location and the second object location; in response to the distance being less than a threshold distance, generating control instructions specifying transportation of the first object to the second object location, wherein the second object location includes an aggregation location; and based on the package label, sending the first and second objects to the destination location from the aggregation location.

In examples of the first variant, the aggregate package parameter includes an updated time estimate and the analysis of the order data and secondary order data includes an analysis of a first individual time estimate associated with the first object and a second individual time estimate associated with the second object.

In examples of the first variant, determining the aggregate package parameter based on the analysis of the order data and the secondary data includes: determining an aggregation time for transport of the first object to the second location; generating a combined time based on combining the aggregation time with the second individual delivery estimate; and generating the updated delivery estimate based on the combined time.

In examples of the first variant, the aggregate package parameter includes an aggregate route, and the analysis of the order data and secondary order data includes an analysis of a first individual route associated with the first object and a second individual route associated with the second object.

In examples of the first variant, determining the aggregate package parameter based on the analysis of the order data and the secondary data includes: determining an aggregation location based on the first individual route and the second individual route; re-routing the first individual route to the aggregation location; and determining the aggregate route based on the aggregation location and the destination location.

In examples of the first variant, the method can additionally include: determining the aggregation location based on a time point and a first corresponding location associated with the time point along the first individual route and a second corresponding location associated with the time point along the second individual route, wherein the time point and the first and second corresponding locations correspond to a minimum point wherein the first and second objects are geographically closest.

In examples of the first variant, the aggregate route is determined based on an optimization between at least carrier rates and an estimated delivery time to the destination location.

In examples of the first variant, the aggregate route is determined based on an aggregation time estimated for first and second object combination into the aggregate package.

In a second variant, a method includes: determining contextual content for a user based on an analysis of order data, wherein the order data is received based on selection of a first object selected by the user; providing the contextual content to the user; based on the provision of the contextual content to the user, receiving secondary order data associated with a second object selected by the user; determining an aggregate parameter based on a combination of the order data and the secondary order data; and aggregating the first and second orders into an aggregate package based on the aggregate parameter.

In examples of the second variant, determining the aggregate parameter includes applying a unit standardization rule to the order data and the secondary order data and thereby generating unit-standardized order data and unit-standardized secondary order data, and comparing the unit-standardized order data and the unit-standardized secondary order data to generate the comparison.

In examples of the second variant, the method further includes determining the aggregate parameter based on a batching model, wherein the batching model includes a decision tree batching model, and wherein determining the aggregate parameter includes: determining a feasibility parameter based on the order data and secondary order data; and determining the aggregate parameter based on the feasibility parameter.

In examples of the second variant, determining the aggregate parameter includes applying the batching model to output a similarity score between the order data and the supplementary order data.

In examples of the second variant, the order data includes a set of order features, wherein the method further includes: assigning a weight to each of the set of order features to generate a weighted set of order features; and computing the contextual content based on the weighted set of order features.

In examples of the second variant, the order data includes a set of related objects related to the first object by a set of product descriptions corresponding to the first object and the set of related objects, wherein determining the contextual content includes selecting a subset of the set of related objects that can be batched into a package including the first object, wherein the selected subset reduces a delivery estimate of the shipment below a threshold value.

In examples of the second variant, the method further includes: in response to receiving the first object at a second object location through a first carrier, packing the first and second objects into an aggregate package at the second object location; and sending the aggregate package to a destination location of the user using a second shipping carrier.

In examples of the second variant, the aggregate parameter includes an aggregation location, wherein the order data and secondary order data respectively includes a first source location and a second source location, wherein determining the aggregate parameter includes determining an aggregate route based on the first source location, the second source location, and a destination location. For example, the aggregate location can be: selected (e.g., from a plurality of candidate locations), predetermined, and/or otherwise determined. In a first specific example, a score is calculated for each of a plurality of candidate aggregate locations based on: the context associated with each candidate aggregate locations, the first and second source locations, the destination location, the routes between the first source location, second source location, the aggregate location, and destination location, and/or any other suitable context; wherein the candidate aggregate location with the best (e.g., highest, lowest) score can be selected as the aggregate location. In this example, the context can be dynamically determined, predetermined, retrieved in real time, estimated, or otherwise determined. In a second specific example, the system can include a database of aggregate locations for each source region(s)-destination region combination, wherein the aggregate location is selected based on the source geographic regions encompassing the first and second source locations and the destination geographic region encompassing the destination location. However, the aggregate location can be otherwise determined. The aggregate location can be determined: after first source location determination, after second source location determination, in real time (e.g., in transit), at the time of second object shipping, and/or at any other suitable time.

In examples of the second variant, the aggregation location is a last-mile distribution center.

In examples of the second variant, the aggregation package is soft-sided.

An alternative embodiment preferably implements the above methods in a computer-readable medium storing computer-readable instructions. The instructions are preferably executed by computer-executable components preferably integrated with a shipping services platform. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

The embodiments include every combination and permutation of the various system components and the various method processes, including any variations, examples, and specific examples.

As a person skilled in the art will recognize from the previous detailed description and from the figures and claims, modifications and changes can be made to the preferred embodiments of the invention without departing from the scope of this invention defined in the following claims.

We claim:

1. A method for object aggregation for a user comprising:
determining an aggregate package parameter, comprising:
based on a first of object selection by the user, receiving order data associated with a first object comprising a destination location for the user and a first location associated with the first object;
generating a content model for the user based cooperatively on the order data and with historical data retrieved from a user database;
using the content model, determining contextual content for the user;
providing the contextual content to the user;
receiving secondary order data associated a second object selection by the user after provision of the contextual content, wherein the secondary order data comprises a second object location associated with the second object; and
determining the aggregate package parameter based on an analysis of the order data and the secondary data;
determining a package label based on the aggregate package parameter; and
providing the package label for the first and second objects.

2. The method of claim 1, further comprising:
receiving the first object at an aggregation location, wherein the aggregation location is distinct from the destination location;
receiving the second object at the aggregation location;
at the aggregation location, packaging the first and second objects within an aggregate package, wherein providing the package label comprises: attaching the package label to the aggregate package; and
based on the package label, sending the aggregate package to the destination location.

3. The method of claim 2, further comprising receiving the first and second objects via distinct shipping carriers.

4. The method of claim 3, further comprising propagating status updates associated with the aggregate package to a first and second tracking number corresponding to the distinct shipping carriers of the first and second objects, respectively.

5. The method of claim 1, further comprising:
determining a distance between the first object location and the second object location;
in response to the distance being less than a threshold distance, generating control instructions specifying transportation of the first object to the second object location, wherein the second object location comprises an aggregation location; and
using the package label, sending the first and second objects to the destination location from the aggregation location.

6. The method of claim 1, wherein the aggregate package parameter comprises an updated time estimate, and wherein the analysis of the order data and secondary order data comprises an analysis of a first individual time estimate associated with the first object and a second individual time estimate associated with the second object.

7. The method of claim 6, further comprising propagating the updated time estimate to each of a first and second tracking number corresponding to the first and second objects, respectively

8. The method of claim 6, wherein determining the aggregate package parameter based on the analysis of the order data and the secondary data comprises:
determining an aggregation time for transport of the first object to the second location;
generating a combined time based on combining the aggregation time with the second individual delivery estimate; and
generating the updated delivery estimate based on the combined time.

9. The method of claim 1, wherein the aggregate package parameter comprises an aggregate route, wherein determining the aggregate package parameter based on the analysis of the order data and the secondary data comprises:
determining an aggregation location based on the first individual route and the second individual route;
re-routing the first individual route to the aggregation location; and
determining the aggregate route based on the aggregation location and the destination location.

10. The method of claim 9, wherein the aggregate route is determined based on an optimization between at least carrier rates and an estimated delivery time to the destination location.

11. The method of claim 10, wherein the aggregate route is further determined based on an aggregation time estimated for first and second object combination into the aggregate package.

12. A method comprising:
determining contextual content for a user based on an analysis of order data, wherein the order data is received based on selection of a first object selected by the user;
providing the contextual content to the user;
based on the provision of the contextual content to the user, receiving secondary order data associated with a second object selected by the user;
determining an aggregate parameter based on a combination of the order data and the secondary order data; and
aggregating the first and second orders into an aggregate package based on the aggregate parameter.

13. The method of claim 12, wherein the aggregate parameter comprises an aggregation location, wherein the order data and secondary order data comprises a first source location and a second source location, respectively, wherein determining the aggregate parameter comprises determining an aggregate route based on the first source location, the second source location, and a destination location.

14. The method of claim 13, wherein the aggregation location is a last-mile distribution center.

15. The method of claim 14, wherein the aggregation package is soft-sided.

16. The method of claim 12, wherein determining the aggregate parameter comprises applying a unit standardization rule to the order data and the secondary order data, thereby generating unit-standardized order data and unit-standardized secondary order data, and comparing the unit-standardized order data and the unit-standardized secondary order data to generate the comparison.

17. The method of claim 16, further comprising determining the aggregate parameter based on a batching model, wherein the batching model comprises a decision tree batching model, and wherein determining the aggregate parameter comprises:
determining a feasibility parameter based on the order data and secondary order data; and
determining the aggregate parameter based on the feasibility parameter.

18. The method of claim 16, wherein determining the aggregate parameter comprises applying the batching model to output a similarity score between the order data and the supplementary order data.

19. The method of claim 18, wherein the order data comprises a set of order features, wherein the method further comprises:
assigning a weight to each of the set of order features to generate a weighted set of order features; and
computing the contextual content based on the weighted set of order features.

20. The method of claim 12, wherein the order data comprises a set of related objects related to the first object by a set of product descriptions corresponding to the first object and the set of related objects, wherein determining the contextual content comprises selecting a subset of the set of related objects that can be batched into a package including the first object, wherein the selected subset reduces a delivery estimate of the shipment below a threshold value.

21. The method of claim 12, further comprising:
in response to receiving the first object at a second object location through a first carrier, packing the first and second objects into an aggregate package at the second object location; and
sending the aggregate package to a destination location of the user using a second shipping carrier.
